(19) United States
(12) Patent Application Publication
(10) Pub. No.: US 2017/0282239 A1
(43) Pub. Date: Oct. 5, 2017

(54) TWO-COMPONENT BINDER SYSTEM FOR THE POLYURETHANE COLD-BOX PROCESS

(71) Applicant: HÜTTENES-ALBERTUS CHEMISCHE WERKE, Düsseldorf (DE)

(72) Inventor: Frank LENZEN, Düsseldorf (DE)

(73) Assignee: HÜTTENES-ALBERTUS Chemische Werke Gesellschaft mit beschränkter Haftung, Düsseldorf (DE)

(21) Appl. No.: 15/510,460

(22) PCT Filed: Sep. 10, 2015
(86) PCT No.: PCT/EP2015/070751

§ 371 Date: Mar. 10, 2017

(30) Foreign Application Priority Data
Sep. 10, 2014 (DE) 10 2014 218 148.8
Jan. 30, 2015 (DE) 10 2015 201 614.5

(51) Int. Cl. B22C 1/22; C08G 18/76; B22C 9/10; C08G 18/54

(52) U.S. Cl. CPC B22C 1/2273; C08G 18/542; C08G 18/7657; B22C 9/10

(57) ABSTRACT

A description is given of a two-component binder system particularly for use in the polyurethane cold box process, a mixture for curing by contacting with a tertiary amine, a method for producing a feeder, a foundry mold or a foundry core, and also feeders, foundry molds and foundry cores producible by this method, and the use of a two-component binder system of the invention or of a mixture of the invention for binding a mold raw material or a mixture of mold raw materials, in particular in the polyurethane cold box process.

The present application relates to a two-component binder system particularly for use in the polyurethane cold box process, a mixture for curing by contacting with a tertiary amine (the term “tertiary amine” in the context of this application also including mixtures of two or more tertiary amines), a method for producing a feeder, a foundry mold or a foundry core, and also feeders, foundry molds and foundry cores producible by this method, and the use of a two-component binder system of the invention or of a mixture of the invention for binding a mold raw material or a mixture of mold raw materials, in particular in the polyurethane cold box process.

In the production of feeders, foundry molds, and foundry cores, the mold raw material is often bound using two-component binder systems which are cold-curing with formation of polyurethane. These binder systems consist of two components: a polyol (normally in solution in a solvent) having at least two OH groups in the molecule (polyol component), and a polyisocyanate (in solution in a solvent or solvent-free) having at least two isocyanate groups in the molecule (polyisocyanate component). In the shaped molding mixture, the two components, added separately to a mold raw material in order to produce a molding mixture, react in a polyaddition reaction to form a cured polyurethane binder. This curing takes place in the presence of basic catalysts, preferably in the form of tertiary amines, which are introduced into the shaping mold with a carrier gas after the molding mixture has been shaped.

The polyol component is usually a phenolic resin in solution in a solvent, i.e., a condensation product of one or more (optionally substituted) phenols with one or more aldehydes (especially formaldehyde). The polyol component is therefore referred to below as phenolic resin component. The phenolic resin component is customarily in the form of a solution having a phenolic resin concentration in the range from 50% to 70%, based on the total mass of the phenolic resin component.

The polyisocyanate component used is a polyisocyanate having at least two isocyanate groups in the molecule, in undissolved form or in solution in a solvent. Aromatic polyisocyanates are preferred. In the case of a polyisocyanate component in the form of a solution, the concentration of the polyisocyanate is generally above 70%, based on the total mass of the polyisocyanate component.

For producing feeders, foundry cores, and foundry molds by the polyurethane cold box process (also termed “urethane cold box process”), a molding mixture is first of all prepared, by the mixing of a granular mold raw material with the two components of the above-described two-component binder system. The proportions of the two components of the two-component binder system are preferably made such as to result in a virtually stoichiometric ratio or an excess of the NCO groups relative to the number of OH groups. Two-component binder systems customary at present typically have an excess of NCO groups of up to 20%, based on the number of OH groups. In the case of foundry cores and foundry molds, the total amount of binder (including, where appropriate, the additives and solvents present in the binder components) is customarily in the range from about 1% to 2%, based on the mass of mold raw material employed, and, in the case of feeders, it is customarily in the range from about 5% to 18%, based on the other constituents of the feeder composition.

The molding mixture is then shaped. This is followed, with brief gassing with a tertiary amine (the term “tertiary amine” in the context of this application also including mixtures of two or more tertiary amines) as catalyst, by the curing of the shaped molding mixture. The amount of catalyst in the form of tertiary amine that is required is in the range from 0.035% to 0.11%, based in each case on the mass of mold raw material employed. Based on the mass of binder, the amount of catalyst in the form of tertiary amine required is typically 3% to 15%, depending on the nature of the tertiary amine used. Subsequently the feeder, the foundry core or the foundry mold can be taken from the shaping mold and used for the casting of metal, such as in engine casting, for example.

During the gassing itself, the feeders, foundry cores and/or foundry molds acquire a measurable strength (referred to as “initial strength” or “instantaneous strength”), which slowly increases, after the end of gassing, to the ultimate strength values. In practice, the desire is for very high initial strengths, to allow the feeders, foundry cores and/or foundry molds to be taken from the shaping mold as soon as possible after gassing, to leave the shaping mold available again for a new operation.

Two-component binder systems which are cold-curing with formation of polyurethane, as described above, are also used in the polyurethane no-bake process. In that process, curing takes place with exposure to a liquid catalyst in the form of a solution of a tertiary amine which is added to the molding mixture.

Two-component binder systems for use in the polyurethane cold box process are described, for example, in U.S. Pat. No. 3,409,579, U.S. Pat. No. 4,546,124, DE 10 2004 057 671, EP 0 771 599, EP 1 057 554 and DE 10 2010 051 567. A two-component binder system for use in the polyurethane no-bake process is described, for example, in U.S. Pat. No. 5,101,001. For economic and environmental reasons it is necessary to reduce the emissions which occur in foundries. With the casting process, some or all of the polyurethane binders formed in the polyurethane cold box process are combusted and cracked, forming toxic and/or highly odorous emissions. Polyurethane binders are typically formed of two components, which in each case, on account of their chemical structure, release aromatic hydrocarbons from the group consisting of benzene, toluene, and xylene (BTX aromatics). The proportion of BTX aromatics, which are hazardous to health, in the emissions from feeders, foundry molds, and foundry cores produced by the polyurethane cold box process is therefore relatively high.

A significant reduction in emissions associated with the polyurethane cold box process can be achieved through a reduction in the binder content of the molding mixture. A lower binder content on the part of the molding mixture has the advantage, additionally, that the amount of tertiary amine required for curing (the term “tertiary amine” for the purposes of this application also including mixtures of two or more tertiary amines) and hence the odor nuisance are reduced. Odor nuisance caused by tertiary amines used in the polyurethane cold box process comes about during the storage of foundry molds, foundry cores and feeders produced by the polyurethane cold box process as well, since tertiary amine absorbed in the polyurethane cold box process is released over time.

A further advantage of a lower polyurethane binder content in the molding mixture is to lower the nitrogen content of the molding mixture. The thermal exposure during casting produces heterocyclic nitrogen compounds from the nitrogen-containing binder, such as 3-methyl-1H-indanole, for example, giving rise to severe odor nuisance. The presence of nitrogen-containing compounds may, furthermore, cause casting defects (nitrogen defects) such as pinhole defects or comma defects, for example. By lowering the binder content of the molding mixture, of course, there must be no detriment to the strength of the feeders, foundry cores, and foundry molds produced from the molding mixture.

It is therefore an object of the present invention to specify a two-component binder system, particularly for use in the polyurethane cold box process, which is capable of endowing feeders, foundry molds, and foundry cores with sufficient strength at the same time as a low binder content and an addition of a small amount of tertiary amines, thus limiting the emissions, particularly of BTX aromatics, and the odor nuisance.

This object is achieved by means of a two-component binder system especially for use in the polyurethane cold box process, consisting of a phenolic resin component (i) and of a separate polyisocyanate component (ii), where

(i) the phenolic resin component comprises
an ortho-fused phenolic resole having etherified and/or free methylol groups, and
a solvent comprising as constituents
(a) one or more compounds from the group of the alkyl silicates and alkyl silicate oligomers and
(b) one or more compounds from the group of the dialkyl esters of C₄-C₆ dicarboxylic acids,
and optionally one or more additives
   and
   (ii) the polyisocyanate component comprises
a polyisocyanate having at least two isocyanate groups per molecule
and also optionally a solvent,
and optionally one or more additives,
   the fraction of the mass of polyisocyanate in the polyisocyanate component (ii) being 90% or more, preferably 92% or more, more preferably 95% or more, very preferably 98% or more, based in each case on the total mass of the polyisocyanate component (ii),
   and
   the ratio of the mass of polyisocyanate in the polyisocyanate component (ii) to the mass of ortho-fused phenolic resole having etherified and/or free methylol groups in the phenolic resin component (i) being less than 1.1, preferably less than 1.0, and at least 0.5.

The ratio of the mass of polyisocyanate in the polyisocyanate component (ii) to the mass of ortho-fused phenolic resole having etherified and/or free methylol groups in the phenolic resin component (i) is in accordance with the invention less than 1.1 and greater than or equal to 0.5. The ratio of the mass of polyisocyanate in the polyisocyanate component (ii) to the mass of ortho-fused phenolic resole having etherified and/or free methylol groups in the phenolic resin component (i) is preferably less than 1.0 and greater than or equal to 0.5.

“Mass of ortho-fused phenolic resole having etherified and/or free methylol groups in the phenolic resin component” pertains to the overall mass of
phenolic resin having etherified methylol groups,
phenolic resin having free methylol groups, and
phenolic resin having free and having etherified methylol groups
   in the phenolic resin component.

In the two-component binder system of the invention, the number of isocyanate groups of the polyisocyanate in the polyisocyanate component (ii) is preferably less than 80%, more preferably 70% to 78%, of the number of free hydroxyl groups of the ortho-fused phenolic resole in the phenolic resin component (i).

Surprisingly it has been found that a two-component binder system of the composition defined above is capable of endowing feeders, foundry molds, and foundry cores, produced in the polyurethane cold box process, with high strength in conjunction with low binder content and addition of a small amount of tertiary amine. The small amounts of binder and tertiary amine limit the emissions, particularly of BTX aromatics, and the odor nuisance. As a result of the smaller ratio than in the prior art between the mass of polyisocyanate in the polyisocyanate component (ii) and the mass of ortho-fused phenolic resole (having etherified and/or free methylol groups) in the phenolic resin component (i), the nitrogen content of the binder is reduced. In addition to the low binder content of the feeders, foundry molds, and foundry cores of the invention, the effect of this reduced nitrogen content is to limit the odor-nuisance emissions of nitrogen-containing compounds during casting, and to reduce the risk of nitrogen-induced casting defects, such as pinhole defects or comma defects, for example.

With particularly preferred two-component binder systems of the invention, it is possible in fact to achieve a disproportionate reduction, in comparison to conventional two-component binder systems for the polyurethane cold box process, in the amount of tertiary amine that is needed in order to achieve a particular strength. The disproportionate reduction, relative to the reduction of the binder content in the molding mixture, in the required amount of tertiary amine corresponds to greater reactivity on the part of the two-component binder system of the invention.

In the two-component binder system of the invention, especially for use in the polyurethane cold box process, the phenolic resin component (i) and the polyisocyanate component (ii) are separate from one another, meaning that they are present in separate containers, since the above-described addition reaction (polyurethane formation) between the resole of the phenolic resin component (i) and the polyisocyanate of the polyisocyanate component (ii) is to take place not until the two components have been mixed with a mold raw material or a mixture of two or more mold raw materials in a molding mixture and this molding mixture has been shaped.

The phenolic resin component (i) of the two-component binder system of the invention comprises a phenolic resin in the form of an ortho-fused phenolic resole. “Ortho-fused phenolic resole” denotes a phenolic resin whose molecules have (a) aromatic rings formed of phenol monomers and linked in ortho-position through methylene ether bridges, and (b) terminal methylol groups arranged in ortho-position. The term “phenol monomers” here encompasses both unsubstituted phenol and substituted phenols, e.g., cresols. The term “ortho-position” identifies the ortho-position in relation to the hydroxyl group of the phenol. It is not impossible for the molecules of the ortho-fused phenolic resoles for inventive use also to contain aromatic rings linked through methylene groups (in addition to aromatic rings (a) linked through methylene ether bridges) and/or terminal hydrogen atoms in ortho-position (as well as terminal methylol groups in ortho-position (b)). In the molecules of the ortho-fused phenolic resoles for inventive use, the ratio of methylene ether bridges to methylene bridges is at least 1, and the ratio of terminal methylol groups in ortho-position to terminal hydrogen atoms in ortho-position is likewise at least 1. Phenolic resins of these kinds are also referred to as benzyl ether resins. They are obtainable by polycondensation of formaldehyde (optionally in the form of paraformaldehyde) and phenols in a molar ratio of greater than 1:1 to 2:1, preferably 1.23:1 to 1.5:1, catalyzed by divalent metal ions (preferably Zn²⁺) in a weakly acidic medium.

The term “ortho-fused phenolic resole” (alternatively ortho-condensed phenolic resole) encompasses, in accordance with the customary understanding of the skilled person, compounds of the kind disclosed in the textbook “Phenolic Resins: A century of progress” (editor: L. Pilato, publisher: Springer, year of publication: 2010), particularly on page 477 in the form of FIG. 18.22. The term equally encompasses the “Benzyl ether resins (ortho-phenol resoles)” stated in the VDG [German Automakers Association] R 305 datasheet on “Urethane Cold Box Process” (February 1998) in 3.1.1. The term further encompasses the “phenolic resins of the benzyl ether resin type” disclosed in EP 1 057 554 B1—cf. in particular paragraphs [0004] to [0006] there.

The ortho-fused phenolic resole of the phenolic resin component (i), for inventive use, contains free methylol groups —CH₂OH and/or etherified methylol groups —CH₂OR. In an etherified methylol group, the hydrogen atom which in the free methylol group —CH₂OH is bonded to the oxygen atom is replaced by a radical R. In a first preferred alternative here, R is an alkyl radical—that is, the groups —CH₂OR are alkoxymethylene groups. Preferred in that case are alkyl radicals having 1 to 4 carbon atoms, preferably from the group consisting of methyl, ethyl, propyl, n-butyl, isobutyl, and tert-butyl.

In another preferred alternative, the radical R of the etherified methylol group of the ortho-fused phenolic resole has the structure

—O—Si(OR1)ₘ(OR2)ₙ, where

R1 is selected from the group consisting of hydrogen and ethyl,
R2 is a radical formed from an ortho-fused phenolic resole as described above,
m and n are each integers from the group consisting of 0, 1, 2, and 3, and m+n=3. In this case the ortho-fused phenolic resole of the phenolic resin component (i) is a modified resole comprising units formed from ortho-fused phenolic resole as described above, which are substituted and/or linked by esters of orthosilicic acid. Resins of this kind are preparable by reaction of free hydroxyl groups (i.e., hydroxyl groups of the unetherified methylol groups) of an ortho-fused phenolic resole with one or more esters of orthosilicic acid. Modified resoles of this kind and their preparation are described in references including patent application WO 2009/130335.

The phenolic resin component (i) preferably comprises an ortho-fused phenolic resole having free methylol groups and also a solvent and optionally one or more additives.

In the ortho-fused phenolic resole of the phenolic resin component (i), the ratio of free methylol groups to etherified methylol groups is preferably greater than 1, more preferably greater than 2, with further preference greater than 4, and very preferably greater than 10. In the ortho-fused phenolic resole of the phenolic resin component (i) there are preferably no etherified methylol groups.

Conventionally employed in two-component binder systems for use in the polyurethane cold box process are, preferably, phenolic resins having etherified methylol groups in the form of alkoxymethylene groups —CH₂—OR, in particular with R=ethoxy or methoxy as described in U.S. Pat. No. 4,546,124, since they give foundry cores and foundry molds particularly high strength. Phenolic resins having etherified methylol groups are therefore also used preferably in practice because they exhibit a greater solubility in apolar solvents such as tetraethyl silicate, for example. Surprisingly it has been found, however, that the objectives of the present invention are achieved more effectively by using an ortho-fused phenolic resole which contains primarily or even exclusively free methylol groups (as defined above).

The fraction of the ortho-fused phenolic resole in the phenolic resin component (i) is preferably in the range from 30 wt % to 50 wt %, more preferably in the range from 40 wt % to 45 wt %, based on the total mass of the phenolic resin component.

The polyisocyanate having at least two isocyanate groups per molecule that is present in the polyisocyanate component (ii) of the two-component binder system of the invention is preferably selected from the group consisting of diphenylmethane diisocyanate (methylenebis(phenyl isocyanate), MDI), polymethylene-polyphenyl isocyanates (polymeric MDI), and mixtures thereof. Polymeric MDI optionally comprises molecules having more than two isocyanate groups per molecule.

As polyisocyanate for the polyisocyanate component (ii) it is also possible to use isocyanate compounds having at least two isocyanate groups per molecule, which additionally contain at least one carbodiimide group per molecule. Such isocyanate compounds are also termed carbodiimide-modified isocyanate compounds and are described in references including DE 10 2010 051 567 A1.

In one preferred alternative, the polyisocyanate component (ii) of the two-component binder system of the invention contains no polyisocyanate in the form of isocyanate compounds having at least two isocyanate groups per molecule which additionally contain per molecule at least one carbodiimide group.

The phenolic resin component (i) of the two-component binder system of the invention comprises a solvent in which the above-described ortho-fused phenolic resole is in solution. The polyisocyanate component (ii) of the two-component binder system of the invention comprises a solvent in which the above-described polyisocyanate having at least two isocyanate groups per molecule is in solution, or comprises no solvent, meaning that the polyisocyanate in the polyisocyanate component (ii) is not in solution.

In accordance with the invention, the solvent for the phenolic resin component (i) comprises as constituents
(a) one or more compounds from the group of the alkyl silicates and alkyl silicate oligomers
   and
(b) one or more compounds from the group of the dialkyl esters of C₄-C₆ dicarboxylic acids.

Our own investigations have determined that a two-component binder system consisting of a phenolic resin component (i) and of a separate polyisocyanate component (ii), where

(i) the phenolic resin component comprises
an ortho-fused phenolic resole having etherified and/or free methylol groups and also
a solvent as defined above
optionally one or more additives
   and
   (ii) the polyisocyanate component comprises
a polyisocyanate having at least two isocyanate groups per molecule,
and also, optionally, a solvent, and
optionally one or more additives,
   the fraction of the mass of polyisocyanate in the polyisocyanate component (ii) being 90% or more, preferably 92% or more, more preferably 95% or more, very preferably 98% or more, based in each case on the total mass of the polyisocyanate component (ii),
   and the ratio of the mass of polyisocyanate in the polyisocyanate component (ii) to the mass of ortho-fused phenolic resole having etherified and/or free methylol groups in the phenolic resin component (i) being less than 1.1, preferably less than 1.0, and at least 0.5
   is capable of endowing feeders, foundry molds, and foundry cores with sufficient strength, in conjunction with low binder content and addition of a small amount of tertiary amine, so that the emissions, especially of BTX aromatics, and the odor nuisance are limited.

In the phenolic resin component (i) of the two-component binder system of the invention, preferably,

the total mass of (a) compounds from the group of the alkyl silicates and alkyl silicate oligomers is 1 wt % to 50 wt %, preferably 5 wt % to 45 wt %, more preferably 10 wt % to 40 wt %, very preferably 15 wt % to 35 wt %
and/or
the total mass of (b) compounds from the group of the dialkyl esters of C₄-C₆ dicarboxylic acids is 5 wt % to 35 wt %, preferably 10 wt % to 30 wt %, more preferably 15 wt % to 25 wt %,
based in each case on the total mass of the phenolic resin component (i).

In the phenolic resin component (i) of the two-component binder system of the invention, preferably,

the total mass of (a) compounds from the group of the alkyl silicates and alkyl silicate oligomers is 1 wt % to 50 wt %, preferably 5 wt % to 45 wt %, more preferably 10 wt % to 40 wt %, very preferably 15 wt % to 35 wt %
and
the total mass of (b) compounds from the group of the dialkyl esters of C₄-C₆ dicarboxylic acids is 5 wt % to 35 wt %, preferably 10 wt % to 30 wt %, more preferably 15 wt % to 25 wt %,
based in each case on the total mass of the phenolic resin component (i).

Preferred as alkyl silicate (a) is tetraethyl silicate (TES), more preferably tetraethyl orthosilicate (TEOS). The dialkyl esters of C₄-C₆ dicarboxylic acids are preferably dimethyl esters of C₄-C₆ dicarboxylic acids.

Preferred is a two-component binder system of the invention in which the solvent of the phenolic resin component (i) comprises:

tetraethyl silicate, more preferably tetraethyl orthosilicate (TEOS), as constituent (a)
and/or
one or more dimethyl esters of C₄-C₆ dicarboxylic acids as constituent (b).

Particularly preferred is a two-component binder system of the invention in which the solvent of the phenolic resin component (i) comprises:

tetraethyl silicate, more preferably tetraethyl orthosilicate (TEOS), as constituent (a)
and
one or more dimethyl esters of C₄-C₆ dicarboxylic acids as constituent (b).

Also preferred is a two-component binder system of the invention in which the solvent of the phenolic resin component (i) comprises not only
(a) one or more compounds from the group of the alkyl silicates and alkyl silicate oligomers and
(b) one or more compounds from the group of the dialkyl esters of C₄-C₆ dicarboxylic acids
   but also one or more compounds selected from the group consisting of
(c) fatty acid alkyl esters, preferably fatty acid methyl esters, more preferably vegetable oil methyl esters, more preferably rapeseed oil methyl esters,
(d) tall oil esters,
(e) alkylene carbonates, preferably propylene carbonate,
(f) cycloalkanes,
(g) cyclic formals such as, for example, 1,3-butanediol formal, 1,4-butanediol formal, glycerol formal, and 5-ethyl-5-hydroxymethyl-1,3-dioxane
(h) one or more substances from the group consisting of cashew nut shell oil, components of cashew nut shell oil, and derivatives of cashew nut shell oil, especially cardol, cardanol, and also derivatives and oligomers of these compounds as described in DE 10 2006 037288,
(i) substituted benzenes and naphthalenes.

The solvent of the phenolic resin component (i) preferably comprises
(a) one or more compounds from the group of the alkyl silicates and alkyl silicate oligomers and
(b) one or more compounds from the group of the dialkyl esters of C₄-C₆ dicarboxylic acids
   and
(c) fatty acid alkyl esters, preferably fatty acid methyl esters, more preferably vegetable oil methyl esters, more preferably rapeseed oil methyl esters.

In the phenolic resin component (i) of the two-component binder system of the invention, preferably,

the total mass of (a) compounds from the group of the alkyl silicates and alkyl silicate oligomers is 5 wt % to 40 wt %, preferably 10 wt % to 35 wt %, very preferably 15 wt % to 30 wt %
and/or
the total mass of (b) compounds from the group of the dialkyl esters of C₄-C₆ dicarboxylic acids is 5 wt % to 35 wt %, preferably 10 wt % to 30 wt %, more preferably 15 wt % to 25 wt %,
and/or
the total mass of (c) fatty acid alkyl esters is 1 wt % to 30 wt %, preferably 5 wt % to 25 wt %, and more preferably 10 to 20 wt %,
based in each case on the total mass of the phenolic resin component (i).

In the phenolic resin component (i) of the two-component binder system of the invention, preferably,

the total mass of (a) compounds from the group of the alkyl silicates and alkyl silicate oligomers is 5 wt % to 40 wt %, preferably 10 wt % to 35 wt %, very preferably 15 wt % to 30 wt %
and
the total mass of (b) compounds from the group of the dialkyl esters of C₄-C₆ dicarboxylic acids is 5 wt % to 35 wt %, preferably 10 wt % to 30 wt %, more preferably 15 wt % to 25 wt %, based in each case on the total mass of the phenolic resin component (i),
and
the total mass of (c) fatty acid alkyl esters is 1 wt % to 30 wt %, preferably 5 wt % to 25 wt %, and more preferably 10 to 20 wt %,
based in each case on the total mass of the phenolic resin component (i).

The solvent of the phenolic resin component (i) more preferably comprises
tetraethyl silicate, more preferably tetraethyl orthosilicate (TEOS), as constituent (a),
one or more dimethyl esters of C₄-C₆ dicarboxylic acids as constituent (b),
and rapeseed oil methyl esters as constituent (c).

The solvent of the polyisocyanate component (ii) preferably comprises one or more compounds selected from the group consisting of
fatty acid alkyl esters, preferably fatty acid methyl esters, more preferably vegetable oil methyl esters, more preferably rapeseed oil methyl esters,
tall oil esters,
alkyl silicates, alkyl silicate oligomers, and mixtures thereof, preferably tetraethyl silicate (TES), more preferably tetraethyl orthosilicate (TEOS),
alkylene carbonates, preferably propylene carbonate,
cycloalkanes,
substituted benzenes and naphthalenes,
cyclic formals such as, for example, 1,3-butanediol formal, 1,4-butanediol formal, glycerol formal, and 5-ethyl-5-hydroxymethyl-1,3-dioxane,
dialkyl esters of C₄-C₆ dicarboxylic acids, preferably dimethyl esters of C₄-C₆ dicarboxylic acids.

Preferably the solvent of the polyisocyanate component (ii) comprises one or more compounds selected from the group of alkylene carbonates, more preferably propylene carbonate. More preferably the solvent of the polyisocyanate component (ii) consists of one or more alkylene carbonates, more particularly propylene carbonate. Very preferably the solvent of the polyisocyanate component (ii) consists of propylene carbonate.

As indicated above, one objective of the present invention is to lower the content of aromatic compounds in molding mixtures, especially for use in the polyurethane cold box process, in order to reduce the emission of aromatic compounds (BTX aromatics). It is therefore preferred that the solvent of the phenolic resin component is free from aromatic compounds and/or that the solvent of the polyisocyanate component is free from aromatic compounds. Accordingly, the abovementioned solvents which are substituted benzenes and naphthalenes and also substances from the group consisting of cashew nut shell oil, components of cashew nut shell oil, and derivatives of cashew nut shell oil are not preferred in accordance with the invention. In the case of substances from the group consisting of cashew nut shell oil, components of cashew nut shell oil, and derivatives of cashew nut shell oil, however, this disadvantage is countered by the advantage of their being obtained from renewable raw materials.

Preferably the solvent of the phenolic resin component (i) and the solvent of the polyisocyanate component (ii) are free from aromatic compounds.

The essential purpose of the solvent present in the polyisocyanate component (ii) in a small amount (10% or less, preferably 8% or less, more preferably 5% or less, very preferably 2% or less, based in each case on the total mass of the polyisocyanate component) is to protect the polyisocyanate from moisture. The polyisocyanate component (ii) of the two-component binder system of the invention preferably contains only an amount of solvent such as is necessary for reliable protection of the polyisocyanate from moisture.

Preferred is a two-component binder system of the invention, especially for use in the polyurethane cold box process, the phenolic resin component (i) and/or the polyisocyanate component (ii) comprising as additive one or more substances selected from the group consisting of
silanes such as, for example, aminosilanes, epoxysilanes, mercaptosilanes, and ureidosilanes and chlorosilanes,
acyl chlorides such as, for example, phosphoryl chloride, phthaloyl chloride, and benzene phosphoroxydichloride,
hydrofluoric acid,
additive mixture preparable by reacting a premix of
(av) 1.0 to 50.0 weight percent of methanesulfonic acid,
(bv) one or more esters of one or more phosphorus-oxygen acids, the total amount of said esters being in the range from 5.0 to 90.0 weight percent,
and
(cv) one or more silanes selected from the group consisting of aminosilanes, epoxysilanes, mercaptosilanes and ureidosilanes, the total amount of said silanes being in the range from 5.0 to 90.0 weight percent,
the weight percent figures being based on the total amount of the constituents (av), (bv), and (cv) in the premix.

For the last-mentioned additive it is the case that in one preferred variant the fraction of water is not more than 0.1 weight percent, the weight percent figures being based on the total amount of the constituents (av), (bv), and (cv) in the premix.

The essential purpose of these additives is to extend the time for which the molding mixture mixed with the two binder components can be stored before further processing into foundry molds or foundry cores, in spite of the high reactivity of the binder system (“sand life”). This is achieved by means of additives which inhibit the formation of polyurethane. Long sand lives are needed so that a prepared batch of a molding mixture does not become unusable prematurely. The aforementioned additives are also referred to as bench life extenders and are known to the skilled person. Used typically here, conventionally, in particular are acyl chlorides from the group consisting of phosphoryl chloride POCl₃ (CAS No. 10025-87-3), o-phthaloyl chloride (1,2-benzenedicarbonyl chloride, CAS No. 88-95-9), and benzenephosphoroxydichloride (CAS No.: 842-72-6). One preferred sand life extender additive is an additive mixture preparable by reacting a premix of the aforementioned components (av), (bv), and (cv) as described in patent application WO 2013/117256. Inhibitory additives are added customarily to the polyisocyanate component (ii) of the two-component binder system of the invention. Their concentration is customarily 0.01% to 2% based on the total mass of the polyisocyanate component (ii).

Further functions of the additives optionally present in the phenolic resin component (i) and/or in the polyisocyanate component (ii) of the two-component binder system of the invention are to facilitate the removal of cured feeders, foundry cores, and foundry molds from the shaping mold and also to increase the stability on storage, particularly the moisture resistance, of the feeders, foundry cores, and foundry molds produced.

On the basis of his or her art knowledge, the skilled person selects these additives such that they are compatible with all of the constituents of the two-component binder system. For example, in two-component binders where the solvent of the phenolic resin component (i) and/or the solvent of the polyisocyanate component (ii) comprises alkyl silicate, the skilled person will not use hydrofluoric acid as an additive.

A further aspect of the present invention relates to a mixture for curing by contacting with a tertiary amine. This mixture of the invention
(A) is preparable by mixing the components of the two-component binder system of the invention as defined above,
   and/or
(B) comprises
   an ortho-fused phenolic resole having etherified and/or free methylol groups,
   a polyisocyanate having at least two isocyanate groups per molecule,
   a solvent comprising as constituents
   (a) one or more compounds from the group of the alkyl silicates and alkyl silicate oligomers and
   (b) one or more compounds from the group of the dialkyl esters of C₄-C₆ dicarboxylic acids,
      and also, optionally, one or more additives,
      the ratio of the mass of polyisocyanate to the mass of ortho-fused phenolic resole having etherified and/or free methylol groups in the mixture being less than 1.1, preferably less than 1.0, and at least 0.5.

A mixture of the invention of this kind can be used for binding a mold raw material or a mixture of mold raw materials in the polyurethane cold box process (see below). The mixture of the invention, especially in its preferred embodiments, is notable for the fact that it endows feeders, foundry molds, and foundry cores produced by the polyurethane cold box process with sufficient strength in conjunction with low binder content and addition of a small amount of tertiary amine. The small amounts of binder and of tertiary amine limit the emissions, especially of BTX aromatics, and the odor nuisance. As a result of the smaller ratio, as compared with the prior art, between the mass of polyisocyanate in the polyisocyanate component (ii) and the mass of ortho-fused phenolic resole having etherified and/or free methylol groups in the phenolic resin component (i), the nitrogen content of the binder is reduced. The effect of this—as well as the low binder content of the feeders, foundry molds, and foundry cores of the invention—is to limit the odor-nuisance emissions of nitrogen-containing compounds during casting and also to reduce the risk of casting defects caused by nitrogen, such as pinhole defects or comma defects, for example.

Variant (A) of the mixture of the invention as described above can be prepared preferably by mixing the components of one of the above-described preferred two-component binder systems of the invention.

For variant (B) of the mixture of the invention as described above, the above observations are applicable with regard to ortho-fused phenolic resoles, polyisocyanates, solvents, additives, and mixing ratios for preferred use.

Preference is given to a mixture of the invention which
(A) is preparable by mixing the components of the two-component binder system of the invention as defined above,
   and
(B) comprises an ortho-fused phenolic resole having etherified and/or free methylol groups,
   a polyisocyanate having at least two isocyanate groups per molecule,
   a solvent comprising as constituents
   (a) one or more compounds from the group of the alkyl silicates and alkyl silicate oligomers and
   (b) one or more compounds from the group of the dialkyl esters of C₄-C₆ dicarboxylic acids,
   and also, optionally, one or more additives,
   the ratio of the mass of polyisocyanate to the mass of ortho-fused phenolic resole having etherified and/or free methylol groups in the mixture being less than 1.1, preferably less than 1.0, and at least 0.5.

A further aspect of the present invention relates to a mixture as defined above, further comprising a mold raw material or a mixture of two or more mold raw materials, the ratio of the total mass of mold raw materials to the total mass of other constituents of the mixture being in the range from 100:2 to 100:0.4, preferably from 100:1.5 to 100:0.6. The other constituents of the mixture encompass all constituents of the mixture which are not mold raw materials, more particularly all components of the two-component binder of the invention, i.e., ortho-fused phenolic resole, polyisocyanate, solvent, and, optionally, additives, as defined above. A mixture of the invention of this kind can be used as a molding mixture for producing a foundry mold or a foundry core by the polyurethane cold box process. A feature of this mixture of the invention, especially in its preferred embodiments, is that foundry molds and foundry cores produced have sufficient strength in conjunction with a low binder content and a low amount of tertiary amine. The small amounts of binder and of tertiary amine limit the emissions, especially of BTX aromatics, and the odor nuisance. As a result of the smaller ratio, as compared with the prior art, between the mass of polyisocyanate in the polyisocyanate component (ii) and the mass of ortho-fused phenolic resole having etherified and/or free methylol groups in the phenolic resin component (i), the nitrogen content of the binder is reduced. The effect of this—as well as the low binder content of the feeders, foundry molds, and foundry cores of the invention—is to limit the odor-nuisance emissions of nitrogen-containing compounds during casting and also to reduce the risk of casting defects caused by nitrogen, such as pinhole defects or comma defects, for example.

Suitable mold raw materials are all mold raw materials customarily used for producing feeders, foundry molds, and foundry cores, examples being silica sand and specialty sands. The term “specialty sand” encompasses natural mineral sands and also sintering and fusion products which are produced in granular form or are converted into granular form by crushing, grinding, and classifying operations, and inorganic mineral sands formed by other physicochemical operations, and used as mold raw materials with conventional foundry binders for the manufacture of feeders, cores, and molds. Specialty sands include the following:
aluminum silicates in the form of natural minerals or mineral mixtures such as J-sand and Kerphalite KF,
aluminum silicates in the form of technical sintered ceramics such as, for example, chamotte and Cerabeads,
natural heavy minerals such as R-sand, chromite sand, and zirconium sand,
technical oxide ceramics such as M-sand and bauxite sand,
and technical non-oxide ceramics such as silicon carbide.

A molding mixture of the invention suitable for producing a feeder by the polyurethane cold box process, i.e., a feeder composition of the invention, comprises

(i) a mixture of the invention which
(A) is preparable by mixing the components of the two-component binder system of the invention as defined above,
or
(B) comprises an ortho-fused phenolic resole having etherified and/or free methylol groups,
   a polyisocyanate having at least two isocyanate groups per molecule,
   a solvent comprising as constituents
   (a) one or more compounds from the group of the alkyl silicates and alkyl silicate oligomers and
   (b) one or more compounds from the group of the dialkyl esters of C₄-C₆ dicarboxylic acids
   and also, optionally, one or more additives as defined above,
   the ratio of the mass of polyisocyanate to the mass of ortho-fused phenolic resole having etherified and/or free methylol groups in the mixture being less than 1.1, preferably less than 1.0, and at least 0.5,
(ii) customary feeder constituents,
   the ratio of the total amount of the customary feeder constituents (ii) to the total amount of the mixture (i) of the invention in the feeder composition being in the range from 100:18 to 100:5. The feeder constituents (ii) encompass refractory granular fillers, optionally insulating fillers such as hollow microspheres, optionally fiber material, and also, in the case of exothermic feeders, an oxidizable metal and an oxidizing agent for the oxidizable metal. The production of feeders by the polyurethane cold box process and also materials suitable as feeder constituents (ii) are known to the skilled person—see, for example, WO 2008/113765 and DE 10 2012 200 967.

A further aspect of the present invention relates to a method for producing a feeder, a foundry mold or a foundry core from a molding mixture, the molding mixture being bound by means of a two-component binder system of the invention as defined above or by means of a mixture of the invention as defined above.

As far as preferred features and embodiments of the two-component binder system of the invention and of the mixture of the invention are concerned, the observations above are valid.

The molding mixture for use in the method of the invention comprises a mold raw material or a mixture of two or more mold raw materials and, for the production of a feeder, the aforementioned feeder constituents. In the production of a feeder, a foundry mold or a foundry core from this molding mixture, the mold raw material or the mixture of two or more mold raw materials is bound by means of the two-component binder system of the invention present in the molding mixture, as defined above, or by means of the mixture of the invention present in the molding mixture, as defined above.

Suitable mold raw material comprises all mold raw materials customarily used for producing feeders, foundry molds, and foundry cores, as specified above.

In one preferred embodiment, the method of the invention comprises the following steps:
providing or producing a mold raw material or a mixture of two or more mold raw materials,
mixing the mold raw material or the mixture of two or more mold raw materials with the phenolic resin component (i) and the polyisocyanate component (ii) of a two-component binder system of the invention (as defined above), to form a molding mixture suitable for curing by contacting with a tertiary amine or with a mixture of two or more gaseous tertiary amines, the ratio of the mass of polyisocyanate to the mass of ortho-fused phenolic resole having etherified and/or free methylol groups being less than 1.1, preferably less than 1.0, and at least 0.5,
shaping the molding mixture,
   and
contacting the shaped molding mixture with a tertiary amine or a mixture of two or more gaseous tertiary amines by the polyurethane cold box process, so that the shaped molding mixture cures to form the feeder, the foundry mold or the foundry core.

The molding mixture is customarily shaped by being filled, blown or shot into a shaping mold and thereafter—optionally—compacted.

The contacting of the shaped molding mixture with a tertiary amine (the term “tertiary amine” for the purposes of this application also including mixtures of two or more tertiary amines) is accomplished preferably in accordance with the polyurethane cold box process.

The tertiary amine is preferably selected from the group consisting of triethylamine, dimethylethylamine, diethylmethylamine, dimethylisopropylamine and mixtures thereof. The tertiary amines to be used are liquid at room temperature and for use in the polyurethane cold box process are evaporated by supply of heat, and the evaporated tertiary amine is sprayed or injected into the shaping mold.

Surprisingly it has emerged that, in preferred variants of the method of the invention, an amount of tertiary amine of less than 0.08 mol, preferably less than 0.05 mol, more preferably less than 0.035 mol per mole of isocyanate groups of the polyisocyanate present in the polyisocyanate component (ii) of the two-component binder system of the invention is sufficient to cure the shaped molding mixture and so to form the feeder, the foundry mold or the foundry core. Lowering the amounts required of tertiary amine is advantageous not only on account of the lower odor nuisance and the reduced costs due to the reduced employment of material, but also on account of the correspondingly lower expenditure on isolating and recycling the tertiary amines.

In one particularly preferred embodiment, the method of the invention comprises the following steps:
providing or producing a mold raw material or a mixture of two or more mold raw materials,
mixing the mold raw material or the mixture of two or more mold raw materials with the phenolic resin component (i) and the polyisocyanate component (ii) of a two-component binder system of the invention (as defined above), to form a molding mixture suitable for curing by contacting with a gaseous tertiary amine or with a mixture of two or more gaseous tertiary amines, the ratio of the mass of polyisocyanate to the mass of ortho-fused phenolic resole having etherified and/or free methylol groups being less than 1.1, preferably less than 1.0, and at least 0.5,
shaping the molding mixture,
   and
contacting the shaped molding mixture with a gaseous tertiary amine or a mixture of two or more gaseous tertiary amines by the polyurethane cold box process, so that the shaped molding mixture cures to form the feeder, the foundry mold or the foundry core, the gaseous tertiary amine or the mixture of two or more gaseous tertiary amines being used in an amount of less than 0.08 mol, preferably less than 0.05 mol, more preferably less than 0.035 mol, of amine per mole of isocyanate groups of the polyisocyanate present in the polyisocyanate component (ii) of the two-component binder system of the invention.

Surprisingly it has emerged that this small amount of gaseous tertiary amine per mole of isocyanate groups of the polyisocyanate present in the polyisocyanate component (ii) of the two-component binder system of the invention is sufficient to cure the shaped molding mixture and so to form the feeder, the foundry mold or the foundry core.

The method of the invention, especially in its preferred embodiments, is notable for the fact that it permits the production of feeders, foundry molds, and foundry cores having a low binder content and addition of a small amount of tertiary amine without adversely affecting the strength of the feeders, foundry molds, and foundry cores. The small amounts of binder and tertiary amine limit the emissions, particularly of BTX aromatics, and the odor nuisance. The effect of the smaller ratio of the mass of polyisocyanate in the polyisocyanate component (ii) to the mass of ortho-fused phenolic resole having etherified and/or free methylol groups in the phenolic resin component (i), as compared with the prior art, is to reduce the nitrogen content of the binder. The effect of this—as well as the low binder content of the feeders, foundry molds, and foundry cores of the invention—is to limit the odor-nuisance emissions of nitrogen-containing compounds during casting and also to reduce the risk of nitrogen-induced casting defects, such as pinhole defects or comma defects, for example.

A further aspect of the present invention relates to a feeder, a foundry mold or a foundry core producible by the method of the invention as described above. With regard to preferred embodiments of the method of the invention, the observations above are valid. The feeders, foundry molds and/or foundry cores of the invention are notable for high strength with low binder content relative to the overall mass of the feeder, the foundry core or the foundry mold.

A further aspect of the present invention relates to the use of a two-component binder system of the invention as defined above or of a mixture of the invention as defined above for binding a mold raw material or a mixture of mold raw materials in the polyurethane cold box process. As far as preferred features and embodiments of the two-component binder system of the invention and of the mixture of the invention are concerned, the observations above are valid.

The invention is elucidated further below using working examples and comparative examples.

From molding mixtures comprising a customary mixture of mold raw materials and also a two-component binder system comprising a polyisocyanate component (ii) and a phenolic resin component (i) as described below, test specimens in the form of flexural bars are produced by the cold box process, and their initial flexural strengths are determined.

The production of cores as test specimens (+GF+ standard flexural strength test specimens) is carried out in accordance with VDG datasheet P73. For this purpose, the mold raw material is charged to a mixing vessel. The calculated amounts of phenolic resin component (i) and polyisocyanate component (ii) (see tables 1, 2 and 3) are then weighed into the mixing vessel in such a way that they do not undergo direct mixing. Thereafter, mold raw material, phenolic resin component (i), and polyisocyanate component (ii) are mixed in a paddle mixer for 2 minutes at approximately 220 revolutions/minute to form a molding mixture.

Core production takes place with a core shooting machine from Multiserw, model KSM2. Immediately after its production as described above, the completed molding mixture is filled into the shooting head of the core shooting machine. The parameters of the core to shooting operation are as follows: shoot time: 3 seconds, delay time after shooting: 5 seconds, shooting pressure: 4 bar (400 kPa). For curing, the test specimens are gassed for 10 seconds at a gassing pressure of 2 bar (200 kPa) with dimethylisopropylamine (DMIPA). The DMIPA (see table 4) is metered using an injection needle. This is followed by flushing with air for 9 seconds at a flushing pressure of 4 bar (400 kPa). The initial flexural strength is measured using a Multiserw LRu-2e instrument at a time of 15 seconds after the end of flushing.

In the production of the test specimens, the following parameters were varied:
nature of the resole in the phenolic resin component (i)
solvent content and solvent composition of the phenolic resin component (i)
solvent content and solvent composition of the polyisocyanate component (ii)
additive present in the polyisocyanate component (ii)
ratio of the mass of polyisocyanate in the polyisocyanate component to the mass of resole in the phenolic resin component (i)
amount of dimethylisopropylamine (DMIPA) used for gassing.

The compositions of the two-component binder systems and molding mixtures used are listed in tables 1, 2, and 3.

In examples 1.1 to 1.5, the phenolic resin component (i) comprises a resole having methanol-etherified terminal methylol groups, i.e., terminal groups of the structure —CH₂—O—CH₃. In all other examples, the phenolic resin component (i) comprises a resole having free (unetherified) terminal methylol groups, i.e., terminal groups of the structure —CH₂OH.

In examples 1.1 to 1.5, 2.1 to 2.5, 3, and 4, the phenolic resin component (i) comprises a solvent comprising dimethyl esters of C₄-C₆ dicarboxylic acids (LM1) and tetraethyl silicate (TES) (LM2). In examples 5.1-5.4, 6.1-6.4, 7.1, 7.2, 8.1, 8.2, 9.1, and 9.2, the phenolic resin component (i) comprises a solvent comprising the following constituents

LM1 dimethyl esters of C₄-C₆ dicarboxylic acids
LM2 tetraethyl silicate (TES) (except for noninventive examples 5.4 and 6.4)
LM3 mixture of aromatic hydrocarbons (examples 5.1-5.4, 7.1, 7.2, 8.1, 8.2, 9.1, 9.2)
LM4 rapeseed oil methyl esters (examples 6.1-6.4, 7.1, 7.2).

The polyisocyanate component (ii) comprises diphenylmethane diisocyanate (methylenebis(phenyl isocyanate), MDI) as polyisocyanate and also a sand life extender additive and optionally a solvent (tetraethyl silicate (TES) in examples 1.1, 2.1, 3, 8.1, and 8.2, propylene carbonate in examples 9.1 and 9.2). The polyisocyanate component (ii) of examples 3, 4, 5.1-5.4, 6.1-6.4, 7.1, 7.2, 8.1, 8.2, 9.1, and 9.2 differs from the polyisocyanate component (ii) of examples 1.1 to 1.5 and 2.1 to 2.5 in the nature of the additive. Whereas in examples 1.1 to 1.5 and 2.1 to 2.5 the polyisocyanate component (ii) comprises conventional bench life extenders from the group of the acyl chlorides as described above, the polyisocyanate component (ii) of all the other examples comprises an additive mixture preparable by reacting a premix of the aforementioned components (av), (bv), and (cv) as described in patent application WO 2013/117256.

In tables 1, 2, and 3, the definitions are as follows:

PBW Parts by weight
MRM Mold raw material

### LM Solvent

### BM Binder

TABLE 1

| | | | | | | | | | | Composition of molding mixture | |
|---|---|---|---|---|---|---|---|---|---|---|---|
| | Composition of | | | | | | | | | PBW | PBW |
| | phenolic resin | | | | | | | | | phenolic | polyiso- |
| | component | | | | | | Composition of | | | resin | cyanate |
| | | | | | | Total | polyisocyanate | | | comp- | comp- |
| | | | | | | amount | component | | | onent/ | onent/ |
| Ex- | | | | | | of | | | Add- | 100 | 100 |
| ample | Resole | LM1 | LM2 | LM3 | LM4 | LM | MDI | LM | itive | PBW | PBW |
| No. | [%] | [%] | [%] | [%] | [%] | [%] | [%] | [%] | [%] | MRM | MRM |
| 1.1 | 53.5 | 21.5 | 25 | 0 | 0 | 46.5 | 79.4 | 19.8 | 0.8 | 0.8 | 0.8 |
| 1.2 | 53.5 | 21.5 | 25 | 0 | 0 | 46.5 | 99 | 0 | 1 | 0.8 | 0.64 |
| 1.3 | 44.6 | 21.5 | 33.9 | 0 | 0 | 55.4 | 99 | 0 | 1 | 1.12 | 0.48 |
| 1.4 | 44.6 | 21.5 | 33.9 | 0 | 0 | 55.4 | 99 | 0 | 1 | 0.96 | 0.64 |
| 1.5 | 44.6 | 21.5 | 33.9 | 0 | 0 | 55.4 | 99 | 0 | 1 | 0.8 | 0.8 |
| 2.1 | 53.5 | 21.5 | 25 | 0 | 0 | 46.5 | 79.4 | 19.8 | 0.8 | 0.8 | 0.8 |
| 2.2 | 53.5 | 21.5 | 25 | 0 | 0 | 46.5 | 99 | 0 | 1 | 0.8 | 0.64 |
| 2.3 | 44.6 | 21.5 | 33.9 | 0 | 0 | 55.4 | 99 | 0 | 1 | 1.12 | 0.48 |
| 2.4 | 44.6 | 21.5 | 33.9 | 0 | 0 | 55.4 | 99 | 0 | 1 | 0.96 | 0.64 |
| 2.5 | 44.6 | 21.5 | 33.9 | 0 | 0 | 55.4 | 99 | 0 | 1 | 0.8 | 0.8 |
| 3 | 44.57 | 21.5 | 33.93 | 0 | 0 | 55.43 | 95.8 | 3 | 1.2 | 1.12 | 0.48 |

| | Composition of molding mixture | | | | | | | |
|---|---|---|---|---|---|---|---|---|
| | | | | | | Amount | Amount | |
| | | | | | | of | of | Amount |
| | PBW | PBW | | PBW | PBW | substance | substance | of sub- |
| | Resole/ | MDI/ | Mass | BM/ | LM/ | [mol] | [mol] | stance |
| Ex- | 100 | 100 | ratio | 100 | 100 | OH/100 | NCO/100 | ratio |
| ample | PBW | PBW | MDI/ | PBW | PBW | PBW | PBW | NCO/ |
| No. | MRM | MRM | resole | MRM | MRM | MRM | MRM | OH |
| 1.1 | 0.428 | 0.635 | 1.484 | 1.07 | 0.53 | 4.043E−03 | 4.807E−03 | 1.189 |
| 1.2 | 0.428 | 0.634 | 1.480 | 1.07 | 0.37 | 4.043E−03 | 4.795E−03 | 1.186 |
| 1.3 | 0.500 | 0.475 | 0.951 | 0.98 | 0.62 | 4.719E−03 | 3.596E−03 | 0.762 |
| 1.4 | 0.428 | 0.634 | 1.480 | 1.07 | 0.53 | 4.045E−03 | 4.795E−03 | 1.186 |
| 1.5 | 0.357 | 0.792 | 2.220 | 1.16 | 0.44 | 3.370E−03 | 5.994E−03 | 1.778 |
| 2.1 | 0.428 | 0.635 | 1.484 | 1.07 | 0.53 | 4.196E−03 | 4.807E−03 | 1.146 |
| 2.2 | 0.428 | 0.634 | 1.480 | 1.07 | 0.37 | 4.196E−03 | 4.795E−03 | 1.143 |
| 2.3 | 0.500 | 0.475 | 0.951 | 0.98 | 0.62 | 4.897E−03 | 3.596E−03 | 0.734 |
| 2.4 | 0.428 | 0.634 | 1.480 | 1.07 | 0.53 | 4.197E−03 | 4.795E−03 | 1.143 |
| 2.5 | 0.357 | 0.792 | 2.220 | 1.16 | 0.44 | 3.498E−03 | 5.994E−03 | 1.714 |
| 3 | 0.499 | 0.460 | 0.921 | 0.96 | 0.64 | 4.893E−03 | 3.480E−03 | 0.711 |

TABLE 2

| | | | | | | | | | | Composition of molding mixture | |
|---|---|---|---|---|---|---|---|---|---|---|---|
| | Composition of | | | | | | | | | PBW | PBW |
| | phenolic resin | | | | | | | | | phenolic | polyiso- |
| | component | | | | | | Composition of | | | resin | cyanate |
| | | | | | | Total | polyisocyanate | | | comp- | comp- |
| | | | | | | amount | component | | | onent/ | onent/ |
| Ex- | | | | | | of | | | Add- | 100 | 100 |
| ample | Resole | LM1 | LM2 | LM3 | LM4 | LM | MDI | LM | itive | PBW | PBW |
| No. | [%] | [%] | [%] | [%] | [%] | [%] | [%] | [%] | [%] | MRM | MRM |
| 4 | 43.54 | 17 | 39.43 | 0.00 | 0.00 | 56.43 | 99 | 0 | 1 | 1.12 | 0.48 |
| 5.1 | 43.54 | 17 | 31.54 | 7.89 | 0.00 | 56.43 | 99 | 0 | 1 | 1.12 | 0.48 |
| 5.2 | 43.54 | 17 | 27.60 | 11.83 | 0.00 | 56.43 | 99 | 0 | 1 | 1.12 | 0.48 |
| 5.3 | 43.54 | 17 | 23.66 | 15.77 | 0.00 | 56.43 | 99 | 0 | 1 | 1.12 | 0.48 |
| 5.4 | 43.54 | 17 | 0.00 | 39.43 | 0.00 | 56.43 | 99 | 0 | 1 | 1.12 | 0.48 |
| 6.1 | 43.54 | 17 | 31.54 | 0.00 | 7.89 | 56.43 | 99 | 0 | 1 | 1.12 | 0.48 |
| 6.2 | 43.54 | 17 | 27.60 | 0.00 | 11.83 | 56.43 | 99 | 0 | 1 | 1.12 | 0.48 |
| 6.3 | 43.54 | 17 | 23.66 | 0.00 | 15.77 | 56.43 | 99 | 0 | 1 | 1.12 | 0.48 |
| 6.4 | 43.54 | 17 | 0.00 | 0.00 | 39.43 | 56.43 | 99 | 0 | 1 | 1.12 | 0.48 |
| 7.1 | 43.54 | 17 | 13.14 | 13.14 | 13.14 | 56.43 | 99 | 0 | 1 | 1.12 | 0.48 |
| 7.2 | 43.54 | 17 | 26.29 | 6.57 | 6.57 | 56.43 | 99 | 0 | 1 | 1.12 | 0.48 |

| | Composition of molding mixture | | | | | | | |
|---|---|---|---|---|---|---|---|---|
| | | | | | | Amount | Amount | |
| | | | | | | of | of | Amount |
| | PBW | PBW | | PBW | PBW | substance | substance | of sub- |
| | Resole/ | MDI/ | Mass | BM/ | LM/ | [mol] | [mol] | stance |
| Ex- | 100 | 100 | ratio | 100 | 100 | OH/100 | NCO/100 | ratio |
| ample | PBW | PBW | MDI/ | PBW | PBW | PBW | PBW | NCO/ |
| No. | MRM | MRM | resole | MRM | MRM | MRM | MRM | OH |
| 4 | 0.488 | 0.475 | 0.974 | 0.97 | 0.63 | 4.780E−03 | 3.596E−03 | 0.752 |
| 5.1 | 0.488 | 0.475 | 0.974 | 0.97 | 0.63 | 4.780E−03 | 3.596E−03 | 0.752 |
| 5.2 | 0.488 | 0.475 | 0.974 | 0.97 | 0.63 | 4.780E−03 | 3.596E−03 | 0.752 |
| 5.3 | 0.488 | 0.475 | 0.974 | 0.97 | 0.63 | 4.780E−03 | 3.596E−03 | 0.752 |
| 5.4 | 0.488 | 0.475 | 0.974 | 0.97 | 0.63 | 4.780E−03 | 3.596E−03 | 0.752 |
| 6.1 | 0.488 | 0.475 | 0.974 | 0.97 | 0.63 | 4.780E−03 | 3.596E−03 | 0.752 |
| 6.2 | 0.488 | 0.475 | 0.974 | 0.97 | 0.63 | 4.780E−03 | 3.596E−03 | 0.752 |
| 6.3 | 0.488 | 0.475 | 0.974 | 0.97 | 0.63 | 4.780E−03 | 3.596E−03 | 0.752 |
| 6.4 | 0.488 | 0.475 | 0.974 | 0.97 | 0.63 | 4.780E−03 | 3.596E−03 | 0.752 |
| 7.1 | 0.488 | 0.475 | 0.974 | 0.97 | 0.63 | 4.780E−03 | 3.596E−03 | 0.752 |
| 7.2 | 0.488 | 0.475 | 0.974 | 0.97 | 0.63 | 4.780E−03 | 3.596E−03 | 0.752 |

TABLE 3

| | | | | | | | | | | Composition of molding mixture | |
|---|---|---|---|---|---|---|---|---|---|---|---|
| | Composition of | | | | | | | | | PBW | PBW |
| | phenolic resin | | | | | | | | | phenolic | polyiso- |
| | component | | | | | | Composition of | | | resin | cyanate |
| | | | | | | Total | polyisocyanate | | | comp- | comp- |
| | | | | | | amount | component | | | onent/ | onent/ |
| Ex- | | | | | | of | | | Add- | 100 | 100 |
| ample | Resole | LM1 | LM2 | LM3 | LM4 | LM | MDI | LM | itive | PBW | PBW |
| No. | [%] | [%] | [%] | [%] | [%] | [%] | [%] | [%] | [%] | MRM | MRM |
| 8.1 | 44.6 | 21.5 | 23.9 | 10.0 | 0.0 | 55.4 | 95.8 | 3.0 | 1.2 | 1.06 | 0.54 |
| 8.2 | 44.6 | 21.5 | 26.9 | 7.0 | 0.0 | 55.4 | 95.8 | 3.0 | 1.2 | 1.06 | 0.54 |
| 9.1 | 44.6 | 21.5 | 23.9 | 10.0 | 0.0 | 55.4 | 95.8 | 3.0 | 1.2 | 1.06 | 0.54 |
| 9.2 | 44.6 | 21.5 | 26.9 | 7.0 | 0.0 | 55.4 | 95.8 | 3.0 | 1.2 | 1.06 | 0.54 |

| | Composition of molding mixture | | | | | | | |
|---|---|---|---|---|---|---|---|---|
| | | | | | | Amount | Amount | |
| | | | | | | of | of | Amount |
| | PBW | PBW | | PBW | PBW | substance | substance | of sub- |
| | resole/ | MDI/ | Mass | BM/ | LM/ | [mol] | [mol] | stance |
| Ex- | 100 | 100 | ratio | 100 | 100 | OH/100 | NCO/100 | ratio |
| ample | PBW | PBW | MDI/ | PBW | PBW | PBW | PBW | NCO/ |
| No. | MRM | MRM | resole | MRM | MRM | MRM | MRM | OH |
| 8.1 | 0.473 | 0.517 | 1.09 | 1.00 | 0.6 | 4.634E−03 | 3.915E−03 | 0.842 |
| 8.2 | 0.473 | 0.517 | 1.09 | 1.00 | 0.6 | 4.634E−03 | 3.916E−03 | 0.842 |
| 9.1 | 0.473 | 0.517 | 1.09 | 1.00 | 0.6 | 4.634E−03 | 3.916E−03 | 0.842 |
| 9.2 | 0.473 | 0.517 | 1.09 | 1.00 | 0.6 | 4.634E−03 | 3.915E−03 | 0.842 |

The results of the measurements of the initial flexural strength as a function of the amount of DMIPA used are compiled in table 4. In table 4, the symbol −/− means that it was not possible to obtain a test specimen that could be removed from the shaping mold without damage.

In noninventive examples 1.1 and 2.1, the two components of the binder system were each used in the quantity and composition customary in the prior art, and so these examples serve as a reference. In noninventive examples 1.2 and 2.2, the solvent-containing polyisocyanate component (ii) of the reference examples was replaced by a solvent-free polyisocyanate component (ii), thus lowering the solvent content of the binder system relative to the reference examples. The binder system of examples 1.2 and 2.2 is more reactive than the binder system of the reference examples, since test specimens which can be removed from the shaping mold without damage are obtained even with smaller amounts of DMIPA. On curing with higher amounts of DMIPA, however, the flexural strength is lower than in the corresponding reference examples. In noninventive examples 1.4 and 2.4, the solvent-containing polyisocyanate component (ii) of the reference examples was replaced by a solvent-free polyisocyanate component (ii) and at the same time the solvent content of the phenolic resin component (i) was increased, and so the solvent content of the binder system corresponds to that of the reference examples. In examples 1.4 and 2.4, the flexural strengths achieved are similar to those in the reference examples.

In examples 1.3, 2.3, 3, 4. 5.1-5.3, 6.1-6.3, 7.1, 7.2, 8.1, 8.2, 9.1, and 9.2, the mass ratio of polyisocyanate MDI to resole and the total mass of polyisocyanate MDI and resole in the molding mixture are reduced relative to the reference examples. In the inventive examples, the flexural strengths achieved are comparable with or even higher than those in the reference examples, despite the binder content of the molding mixture being lower than in the reference examples. The binder system of the invention, moreover, is more reactive than the binder system of the reference examples, since high initial flexural strengths are obtained even with much lower amounts of DMIPA.

Shifting the ratio of the mass of polyisocyanate MDI to the mass of resole to values of greater than 1.1, more particularly greater than 2 (see noninventive examples 1.5 and 2.5), has the effect of significantly reducing the flexural strength and the reactivity, since test specimens which can be removed from the shaping mold without damage are obtained only on gassing with relatively high quantities of DMIPA.

In inventive examples 1.3, 2.3, and 3, 4. 5.1-5.3, 6.1-6.3, 7.1, and 7.2, the fractions of polyisocyanate and hence of nitrogen are reduced by 25% relative to the reference examples. In inventive examples 8.1, 8.2, 9.1, and 9.2, the fractions of polyisocyanate and therefore of nitrogen are reduced by 19% relative to the reference examples. The effect of this is to limit the odor-nuisance emissions of nitrogen-containing compounds on casting and also to reduce the risk of nitrogen-induced casting defects, such as pinhole defects or comma defects, for example.

Particularly high strengths, even at low quantities of DMIPA, are achieved in inventive examples 1.3, 2.3, 3, and 4, in which the solvent of the phenolic resin component consists of
(a) a compound from the group of the alkyl silicates and alkyl silicate oligomers and
(b) compounds from the group of the dialkyl esters of C₄-C₆ dicarboxylic acids.

On account of the comparatively high price of tetraethyl silicate, however, it is desirable to reduce the fraction of tetraethyl silicate. In the further examples, in comparison to example 4, tetraethyl silicate is replaced to a certain fraction by a mixture of aromatic hydrocarbons (LM3, examples 5.1-5.4, 7.1, 7.2, 8.1, 8.2, 9.1, and 9.2) or rapeseed oil methyl esters (LM4, examples 6.1-6.4, 7.1, 7.2). In noninventive examples 5.4 and 6.4, the amount of tetraethyl silicate in comparison to example 4 is replaced entirely by LM3 and LM4, respectively. LM3 and LM4 are customary prior-art solvents for phenolic resins in the polyurethane cold box process. On account of the desired reduction in the emission of aromatic compounds (BTX aromatics) in the polyurethane cold box process, however, the use of LM3 is not preferred.

As the amount of tetraethyl silicate goes up (LM2, inventive examples 4, 5.1-5.3, 6.1-6.3, 7.1, 7.2, 8.1, 8.2, 9.1, and 9.2), there is an increase in the strength values in comparison to noninventive examples 5.4 and 6.4. This shows that tetraethyl silicate produces an improvement even in combination with customary prior-art solvents for phenolic resins in the polyurethane cold box process.

In the polyisocyanate component as well it is desirable to replace tetraethyl silicate by more favorable solvents. Thus with propylene carbonate as solvent of the polyisocyanate component (inventive examples 9.1 and 9.2), higher strengths can be achieved than with tetraethyl silicate as solvent of the polyisocyanate component (inventive examples 8.1 and 8.2). With propylene carbonate in place of tetraethyl silicate as solvent of the polyisocyanate component, greater strengths are achieved even when at the same time the fraction of tetraethyl silicate (LM2) in the solvent mixture of the phenolic resin component is lowered—see inventive examples 8.2 and 9.1.

Further advantages of the invention lie inter alia in the high flowability and low sticking tendency of the molding mixture with the two-component binder system of the invention. This molding mixture is very dry in its effect. On production of the test specimens from the molding mixture of the invention, a very sharp contouring and high modeling accuracy are apparent. The test specimens obtained are notable for high edge strength.

With preferred two-component binder systems of the invention, relative to conventional two-component binder systems, it is possible to reduce the BTX emissions (emissions of benzene, toluene, and xylene, measured at 700° C.) from foundry cores and foundry molds produced by the polyurethane cold box process by 50% or more during casting.

TABLE 4

| | Initial flexural strength N/cm² | | |
|---|---|---|---|
| | for different amounts of DMIPA | | |
| Example | (based on the mass of the mold raw material used) | | |
| No. | 0.0129% | 0.0401% | 0.0936% |
| 1.1 | 160 | 320 | 340 |
| 1.2 | 170 | 240 | 270 |
| 1.3 | 230 | 280 | 300 |
| 1.4 | 110 | 280 | 330 |
| 1.5 | —/— | 190 | 210 |
| 2.1 | 110 | 290 | 330 |
| 2.2 | 100 | 170 | 210 |
| 2.3 | 210 | 320 | 360 |
| 2.4 | 120 | 240 | 290 |
| 2.5 | —/— | 150 | 210 |
| 3 | 260 | 330 | 330 |
| 4 | 250 | 260 | 260 |
| 5.1 | 220 | 220 | 240 |
| 5.2 | 210 | 210 | 230 |
| 5.3 | 200 | 200 | 220 |
| 5.4 | 180 | 180 | 210 |
| 6.1 | 230 | 240 | 240 |
| 6.2 | 210 | 220 | 230 |
| 6.3 | 200 | 210 | 210 |
| 6.4 | 50 | 50 | 50 |
| 7.1 | 119 | 210 | 220 |
| 7.2 | 210 | 230 | 240 |
| 8.1 | 210 | 230 | 250 |
| 8.2 | 220 | 240 | 250 |
| 9.1 | 230 | 250 | 260 |
| 9.2 | 240 | 260 | 260 |

1. A two-component binder system for use in the polyurethane cold box process consisting of a phenolic resin component (i) and of a separate polyisocyanate component (ii), where
(i) the phenolic resin component comprises
an ortho-fused phenolic resole having etherified and/or free methylol groups, and
a solvent comprising as constituents
(a) one or more compounds from the group of the alkyl silicates and alkyl silicate oligomers and
(b) one or more compounds from the group of the dialkyl esters of C₄-C₆ dicarboxylic acids,
optionally one or more additives
and
(ii) the polyisocyanate component comprises
a polyisocyanate having at least two isocyanate groups per molecule
and also optionally a solvent, and
optionally one or more additives,
the fraction of the mass of polyisocyanate in the polyisocyanate component (ii) being 90% or more based on the total mass of the polyisocyanate component (ii),
and
the ratio of the mass of polyisocyanate in the polyisocyanate component (ii) to the mass of ortho-fused phenolic resole having etherified and/or free methylol groups in the phenolic resin component (i) being less than 1.1.

2. The two-component binder system as claimed in claim 1, the solvent of the phenolic resin component (i) comprising:
tetraethyl silicate as constituent (a)
and/or
one or more dimethyl esters of C₄-C₆ dicarboxylic acids as constituent (b).

3. The two-component binder system as claimed in claim 1, the solvent of the phenolic resin component (i) further comprising:
one or more compounds selected from the group consisting of
(c) fatty acid alkyl esters, preferably fatty acid methyl esters, more preferably vegetable oil methyl esters, more preferably rapeseed oil methyl esters,
(d) tall oil esters,
(e) alkylene carbonates, preferably propylene carbonate,
(f) cycloalkanes,
(g) cyclic formals.

4. The two-component binder system as claimed in claim 1, the ratio of free methylol groups to etherified methylol groups in the ortho-fused phenolic resole being greater than 1, there preferably being no etherified methylol groups in the ortho-fused phenolic resole.

5. The two-component binder system as claimed in claim 1, the polyisocyanate having at least two isocyanate groups per molecule being selected from the group consisting of diphenylmethane diisocyanate, polymethylene-polyphenyl isocyanates (polymeric MDI), and mixtures thereof.

6. The two-component binder system as claimed in claim 1, the solvent of the polyisocyanate component (ii) comprising one or more compounds selected from the group consisting of
fatty acid alkyl esters,
tall oil esters,
alkyl silicates, alkyl silicate oligomers, and mixtures thereof,
alkylene carbonates,
cycloalkanes,
cyclic formals,
and
dialkyl esters of C₄-C₆ dicarboxylic acids.

7. The two-component binder system as claimed in claim 1, the solvent of the phenolic resin component (i) being free from aromatic compounds and/or the solvent of the polyisocyanate component (ii) being free from aromatic compounds.

8. The two-component binder system as claimed in claim 1, the phenolic resin component (i) and/or the polyisocyanate component (ii) comprising as additive one or more substances selected from the group consisting of
silanes,
acyl chlorides,
hydrofluoric acid,
additive mixture preparable by reacting a premix of
(av) 1.0 to 50.0 weight percent of methanesulfonic acid,
(bv) one or more esters of one or more phosphorus-oxygen acids, the total amount of said esters being in the range from 5.0 to 90.0 weight percent,
and
(cv) one or more silanes selected from the group consisting of aminosilanes, epoxysilanes, mercaptosilanes and ureidosilanes, the total amount of said silanes being in the range from 5.0 to 90.0 weight percent,
the weight percent figures being based on the total amount of constituents (av), (bv), and (cv) in the premix.

9. A mixture for curing by contacting with a tertiary amine or a mixture of two or more tertiary amines, the mixture
(A) being preparable by mixing the components of the two-component binder system as claimed in claim 1,
and/or
(B) comprising an ortho-fused phenolic resole having etherified and/or free methylol groups,
a polyisocyanate having at least two isocyanate groups per molecule,
a solvent comprising as constituents
(a) one or more compounds from the group of the alkyl silicates and alkyl silicate oligomers and
(b) one or more compounds from the group of the dialkyl esters of C₄-C₆ dicarboxylic acids,
and also, optionally, one or more additives,
the ratio of the mass of polyisocyanate to the mass of ortho-fused phenolic resole having etherified and/or free methylol groups in the mixture being less than 1.1.

10. The mixture as claimed in claim 9, further comprising a mold raw material or a mixture of two or more mold raw materials, the ratio of the total mass of mold raw materials to the total mass of other constituents of the mixture being in the range from 100:2 to 100:0.4.

11. A method for producing a feeder, a foundry mold or a foundry core from a molding mixture, the molding mixture being bound by means of a two-component binder system as claimed in claim 1 or by means of a mixture comprising the two-component binder system.

12. The method as claimed in claim 11, comprising the following steps:
providing or producing a mold raw material or a mixture of two or more mold raw materials,
mixing the mold raw material or the mixture of two or more mold raw materials with the phenolic resin component (i) and the polyisocyanate component (ii) of a two-component binder system as claimed in claim 1, to form a molding mixture suitable for curing by contacting with a tertiary amine or with a mixture of two or more tertiary amines, the ratio of the mass of polyisocyanate to the mass of ortho-fused phenolic resole having etherified and/or free methylol groups being less than 1.1,
shaping the molding mixture,
and
contacting the shaped molding mixture with a tertiary amine or a mixture of two or more tertiary amines by the polyurethane cold box process, so that the shaped molding mixture cures to form the feeder, the foundry mold or the foundry core.

13. The method as claimed in claim 11, comprising the following steps:
providing or producing a mold raw material or a mixture of two or more mold raw materials,
mixing the mold raw material or the mixture of two or more mold raw materials with the phenolic resin component (i) and the polyisocyanate component (ii) of a two-component binder system as claimed in claim 1, to form a molding mixture suitable for curing by contacting with a gaseous tertiary amine or with a mixture of two or more gaseous tertiary amines, the ratio of the mass of polyisocyanate to the mass of ortho-fused phenolic resole having etherified and/or free methylol groups being less than 1.1,
and
contacting the shaped molding mixture with a gaseous tertiary amine or a mixture of two or more gaseous tertiary amines by the polyurethane cold box process, so that the shaped molding mixture cures to form the feeder, the foundry mold or the foundry core, the gaseous tertiary amine or the mixture of two or more gaseous tertiary amines being used in an amount of less than 0.08 mol per mole of isocyanate groups.

14. A feeder, foundry mold or foundry core producible by a method as claimed in any of claim 11.

15. A polyurethane cold box process, comprising:
Binding a mold raw material or a mixture of mold raw materials with a two-component binder system as claimed in claim 1.
